(19) United States
(12) Patent Application Publication
(10) Pub. No.: US 2016/0216884 A1
(43) Pub. Date: Jul. 28, 2016

(54) COPYING-DEGREE CALCULATION SYSTEM, METHOD AND STORAGE MEDIUM

(71) Applicant: KABUSHIKI KAISHA TOSHIBA, Tokyo (JP)

(72) Inventors: Shihomi Takahashi, Yokohama Kanagawa (JP); Kazunori Imoto, Kawasaki Kanagawa (JP); Tomoyuki Shibata, Kawasaki Kanagawa (JP); Osamu Yamaguchi, Yokohama Kanagawa (JP); Isao Mihara, Tokyo (JP)

(21) Appl. No.: 14/849,407

(22) Filed: Sep. 9, 2015

(30) Foreign Application Priority Data
Jan. 28, 2015 (JP) 2015-014012

(51) Int. Cl. G06F 3/0488; G06F 17/24

(52) U.S. Cl. CPC G06F 3/04883; G06F 17/242

(57) ABSTRACT

According to one embodiment, a computer-implemented method includes inputting stroke data indicative of a coordinate and time of a handwritten stroke, and calculating a degree of copying of the handwritten stroke based on a frequency distribution of feature amounts of the input stroke data.

### CROSS-REFERENCE TO RELATED APPLICATIONS

This application is based upon and claims the benefit of priority from Japanese Patent Application No. 2015-014012, filed Jan. 28, 2015, the entire contents of which are incorporated herein by reference.

### FIELD

Embodiments described herein relate generally to a copying-degree calculation system and method.

### BACKGROUND

There is a dishonest-act detection server configured to compare answer data items of examinees that were made in, for example, an examination venue, using stylus devices, thereby detecting an answer data item that may result from cheating, based on degrees of similarity in the answer data items. There is also an electronic notebook system configured to estimate thinking conditions of the user of an electronic stylus, based on the attitude of the stylus and time data associated with the attitude. Further, there is a device for quantifying spatio-temporal data associated with a handwritten character string or picture of a writer, thereby extracting a feature amount and determining a psychological and/or physiological state of the writer.

In the prior art, however, although the psychological and/or physiological state of the writer can be determined by analyzing handwritten content, it is necessary to handwrite particular content in order to enable the analysis. Furthermore, states of handwriting include two states, i.e., a state where a user is handwriting a document using their imagination, and a state where the user merely copies a document. These two states cannot be discriminated.

### BRIEF DESCRIPTION OF THE DRAWINGS

FIG. 1 is a perspective view showing an appearance example of a tablet according to an embodiment.

FIG. 2 is a block diagram showing an example of an entire system including the tablet of FIG. 1.

FIG. 3 is a view showing an example of a handwritten character string.

FIG. 4 is a view showing an example of stroke data corresponding to the handwritten character string of FIG. 3.

FIG. 5 is a block diagram showing a configuration example of the tablet of FIG. 1.

FIG. 6 is a block diagram showing a configuration example of a copying-degree calculation program shown in FIG. 5.

FIG. 7 is a view showing examples of distances between sample points and velocities as statistical values calculated from the stroke data.

FIG. 8 is a view showing an example of the distance between the centroids of each pair of strokes.

FIG. 9 is a view showing examples of the time difference and the move amount between two strokes.

FIG. 10 is a view showing an example of a variation in the move amount between two strokes.

FIG. 11 is a view showing examples of variations in the distance between the centroids of two strokes, the time difference between the two strokes, and the move amount between the two strokes.

FIGS. 12A and 12B show examples of a regression analysis associated with time differences and frequency distributions.

FIG. 13 shows an example of learning of a regression line.

FIG. 14 is an exemplary flowchart for explaining processing in a first operation mode according to the embodiment.

FIG. 15 is a schematic view showing an example of use of an electronic device according to the embodiment.

FIG. 16 is an exemplary flowchart for explaining processing in a second operation mode according to the embodiment.

### DETAILED DESCRIPTION

Various embodiments will be described hereinafter with reference to the accompanying drawings.

In general, according to one embodiment, a computer-implemented method includes inputting stroke data indicative of a coordinate and time of a handwritten stroke; and calculating a degree of copying of the handwritten stroke based on a frequency distribution of feature amounts of the input stroke data.

According to one embodiment, stroke data corresponding to a handwritten character string is acquired, a feature amount indicating the state of writing of a user is extracted from the stroke data, and it is determined whether the writing state is a copying state, using a regression equation based on a frequency distribution of feature amounts in a certain area of a handwritten document. Between a state where the user is handwritten a document while thinking, and a state where they are merely copying an existing document, different feature-amount distributions are obtained since these two states differ in cognitive load, depending upon, for example, whether they are thinking or not. For example, when the user is merely copying the existing document, there is a tendency for the degree distribution of the feature amount to exhibit a small variance, whereas when the user is writing a story while thinking, there is a tendency for the degree distribution of the feature amount to exhibit a great variance. Accordingly, the degree of copying can be determined from the degree distribution of the feature amount.

Determination of a handwriting state utilizing the degree of copying is applicable to various situations. In the embodiment, a description will be given of a case where a student handwrites an answer for homework or distance learning, using a handwriting-enabled electronic device, such as a tablet, a notebook computer, or a desktop computer. In the case of homework or distance learning, it is difficult for a teacher to directly supervise a student's action, and there are few clues to specifying a student's weak point or point to notice. However, based on stroke data corresponding to a handwritten answer created by a student using a handwriting-enabled electronic device, a period elapsing from the issue of a question to the output of the answer, or the movement of an electronic stylus used to handwrite the answer, may be obtained as a clue. If a long time is required until the answer is obtained after the question is asked, it can be determined that the student is thinking to give the answer, and that they do not sufficiently understand the question. In contrast, if the student is copying the answer or correct solution of another student, they may be misunderstood to sufficiently understand the question. Further, if answers of a plurality of students are compared, one who is performing a dishonest act, such as cheating, may be detected. However, it is not practical to always compare student's answers.

In view of the above, in the embodiment, the degree of copying when a user is handwriting a character string is detected based on stroke data corresponding to the handwritten character string. From this, it can be determined to what degree the user understands, and appropriate data can be provided to, for example, a teacher.

### EMBODIMENT

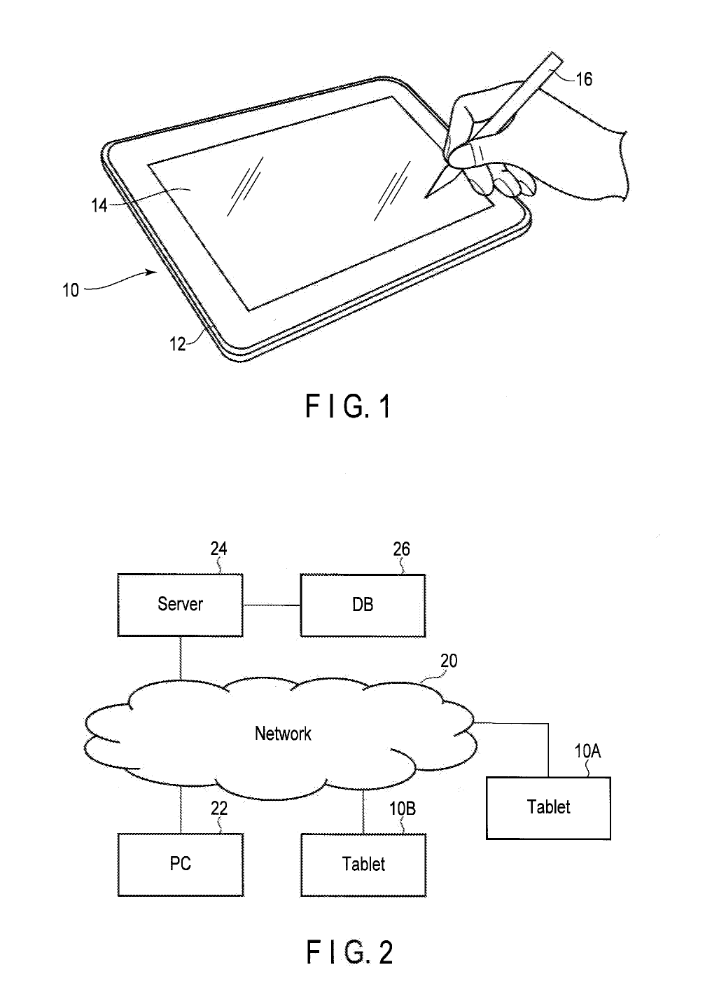

FIG. 1 is a perspective view showing an appearance example of an electronic device according to an embodiment. Although the electronic device of the embodiment is a tablet 10, it may be a notebook computer, a desktop computer, etc. It is sufficient if it is a handwriting-enabled one. The tablet 10 includes a main unit 12 and a touch screen display 14. The touch screen display 14 is attached to the main unit 12, superposed on the upper surface of the main unit 12.

The main unit 12 has a casing like a thin box. The touch screen display 14 includes a flat panel display, and a sensor configured to detect the contact position of a stylus or a finger on the screen of the flat panel display, move of the contact position, etc. The flat panel display may be, for example, a liquid crystal display (LCD). As the sensor, an electrostatic capacitive touch panel, an electromagnetic induction type digitizer, etc. can be used. In the embodiment, two types of sensors, i.e., the digitizer and the touch panel, are both built in the touch screen display 14. The digitizer is placed under the screen of the flat panel display, for example. The touch panel is placed on the screen of the flat panel display, for example. This structure enables the touch screen display 14 to detect not only a touch operation on the screen using a finger, but also a touch operation on the screen using a stylus 16. The stylus 16 is, for example, a digitizer stylus (electromagnetic induction stylus), an active stylus, a passive stylus, etc.

FIG. 2 is a block diagram of an entire system including the tablet 10. Tablets 10A, 10B, . . . , used by a lot of students are connected to a network 20. A computer 22 for a teacher who assigns questions to students and grades answers thereto is also connected to the network 20. The apparatus for students may not be limited to the tablet, but may be a handwriting-enabled computer. Although a handwriting function is not indispensable to the apparatus for the teacher, a tablet may be used as an apparatus for the teacher. Only the teacher but also student's parents see students' answers. An apparatus for the parents may be the same as the teacher's one. Alternatively, the same tablet as that for the students may be used for the parents, and the function of the apparatus may be switched among the users.

In the embodiment, processing of extracting a feature amount and processing of detecting the degree of copying may be realized as functions of the tablet 10 that acquires stroke data. Alternatively, the tablet 10 may be limited to a function of inputting characters by handwriting and a function of acquiring stroke data corresponding to the input characters, The above-mentioned functions, a function of displaying processing results, a function of issuing questions, etc., may be realized as those of the computer 22 for teachers, or a server 24 connected to the network 20. A database 26, which is a mass storage device, is connected to the server 24. The database 26 can store questions for students, stroke data indicating handwritten answers, data indicating degrees of copy associated with the stroke data corresponding to the answers.

When the user of the tablet 10 handwrites a character on the touch screen display 14, using an external object (hereinafter, referred to as the stylus 16), the locus of move of the stylus 16 on a screen is sampled, whereby stroke data including coordinates and acquisition time points of sample points is acquired. Strokes expressed by the stroke data are drawn on the touch screen display 14. The locus of move of the stylus 16 after touching the screen until releasing therefrom corresponds to one stroke. Each character consists of at least one stroke.

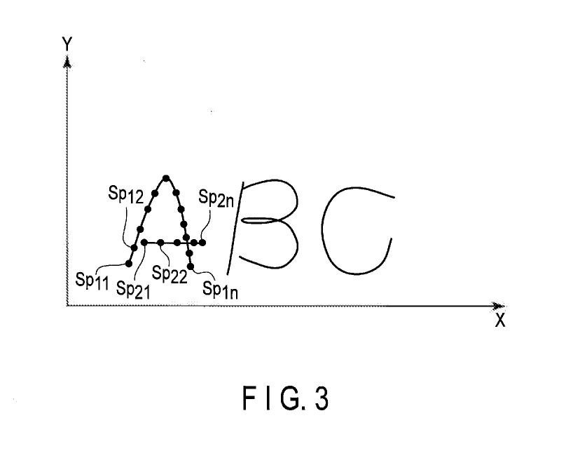

FIG. 3 shows a handwriting document example comprising characters handwritten on the touch screen display 14, using, for example, the stylus 16. Character “A” consists of two strokes (a stroke of “ [symbol] ” and a stroke of “-”). Character “B” also consists of two strokes. Character “C” consists of one stroke. Strokes are sampled at regular time or space intervals, and n sample points Sp11, Ssp12, . . . , Sp1n, which constitute the stroke of “ [symbol] ” are obtained. Similarly, the other strokes are sampled to obtain sample points Sp. Since the moving velocity of the stylus is not necessarily constant, and strokes have different lengths, the distance between each pair of sample points sampled at regular intervals is not constant, and the total number of sample points differs stroke by stroke.

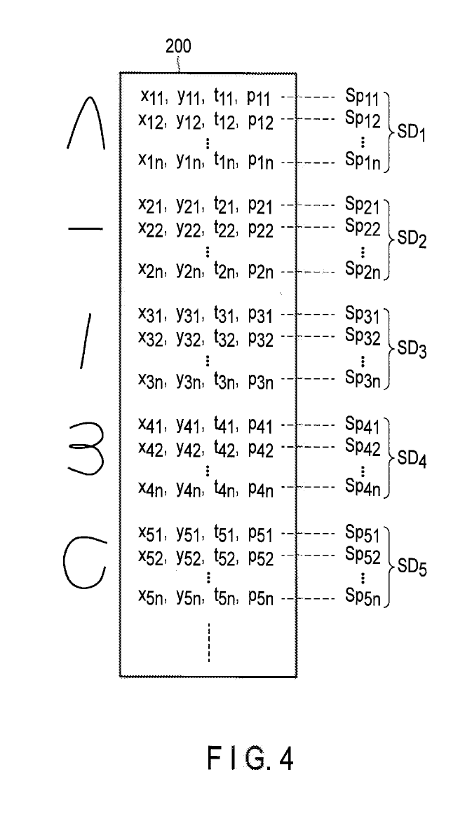

FIG. 4 shows stroke data 200 corresponding to the document of FIG. 3. The stroke data 200 corresponding to the handwritten document includes stroke data items SD1, SD2, . . . , SD5 corresponding to respective strokes. Stroke data items SD1, SD2, . . . , SD5 are arranged in order of handwriting. Leading two stroke data items SD1 and SD2 indicate the two strokes of handwritten character “A.” Third and fourth stroke data items SD3 and SD4 indicate two strokes constituting handwritten character “B.” Fifth stroke data item SD5 indicates one stroke constituting handwritten character “C.”

Each stroke data SD consists of data corresponding to a plurality of sample points Sp on one stroke. The data of a respective sample point Sp includes the coordinates (x, y) of the respective sample point input by the digitizer, and the observation time (time when the respective sample point was handwritten) t of the respective sample point. The observation time t may be set to an absolute time (for example, year, month, day, hour, second), or a relative time with respect to a certain time. For instance, each stroke data item SD may include an absolute time (for example, year, month, day, hour, second) T at which a corresponding stroke starts to be handwritten, and each sample point may include, as the observation time t, a relative time indicating a difference to the absolute time T.

In the embodiment, the state of handwriting can be known from the coordinates and time of each sample point, and the degree of copying is calculated based on the state. However, the stroke data may include data other than the coordinates and time.

The data of a respective sample point Sp may include the stylus pressure p, which is exerted on the stylus 16 by the touch screen display 14 when the respective sample point is handwritten. For instance, the stylus pressure of the stylus 16 can be detected, if a variable capacitor having its capacitance varied when pressure is applied to the tip of the stylus 16 is built in the stylus 16, and if a variation in the resonance frequency of a resonator circuit formed by the variable capacitor and an inductance in the stylus 16 is detected by the digitizer. The stylus pressure detection method is not limited to this, but may be any other appropriate pressure detection method.

Furthermore, the data of the respective sample point Sp may include data indicating the inclination of the stylus 16 (i.e., the angle formed between the input screen and the stylus) when the respective sample point is handwritten. For example, the angle between the input screen and the stylus 16 (i.e., the inclination of the stylus to the axis intersecting perpendicular to the input screen) can be detected if a pair of electrodes are built in the tip of the stylus 16, and if the positions of the two electrodes are detected by the digitizer and are subjected to calculation. The inclination detection method is not limited to this, but may be any other appropriate inclination detection method.

The expression form of stroke data is not limited to that of FIG. 4. It is sufficient if the form includes data indicating coordinates, time, stylus pressure, etc.

Further, although in the embodiment, stroke data is input by handwriting strokes on the touch screen display 14, using a stylus or finger, this may be performed using a touchpad, a mouse, etc.

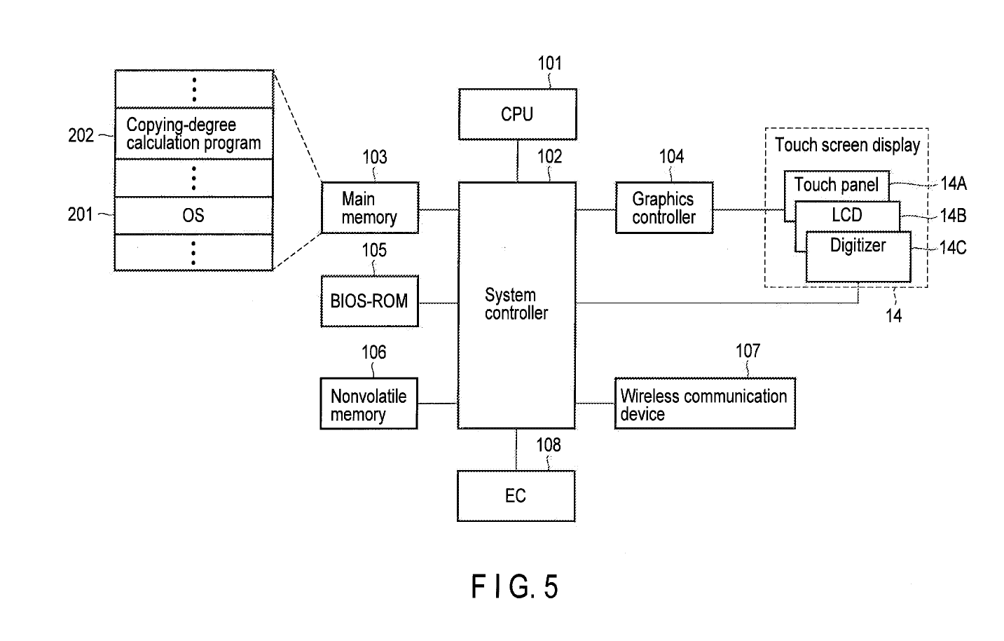

FIG. 5 is a view showing the system configuration of the tablet 10. The computer 22 for teachers is the same in configuration basically. The tablet 10 includes a CPU 101, a system controller 102, a main memory 103, a graphics controller 104, a BIOS-ROM 105, a nonvolatile semiconductor memory (called nonvolatile memory) 106, a wireless communication device 107, an embedded controller (EC) 108, etc.

The CPU 101 is a processor for controlling the operations of various components in the computer 10. The CPU 101 executes various types of software loaded from the nonvolatile memory 106 onto the main memory 103. The software includes an operating system (OS) 201 and various application programs. The application programs include a copying-degree calculation program 202. As mentioned above, at least some modules included in the copying-degree calculation program 202 may be provided in devices other than the tablet 10, for example, the computer 22 for teachers, the server 24, etc.

The CPU 101 also executes a basic input/output system (BIOS) stored in the BIOS-ROM 105. The BIOS is a program for hardware control.

The system controller 102 is a device that connects the CPU 101 to each module. The system controller 102 includes a memory controller (not shown) for performing access control of the main memory 103.

The graphics controller 104 is a display controller which controls an LCD 14B used as a display monitor of the tablet 10. A display signal generated by the graphics controller 104 is sent to the LCD 14B. The LCD 14B displays a screen image based on the display signal. A touch panel 14A is provided on the LCD 14B. A digitizer 14C is provided under the LCD 14B. The digitizer 14C detects the contact position of the stylus 16 on the screen, the move of the contact position on the screen, the contact pressure (stylus pressure) of the stylus 16, the inclination of the stylus, etc.

The wireless communication device 107 is configured to execute wireless communication, such as a wireless LAN or 3G mobile communication. The EC 108 is a one-chip microcomputer including an embedded controller for power management. The EC 108 has a function of turning on and off the tablet computer 10 in accordance with a user's operation of a power button.

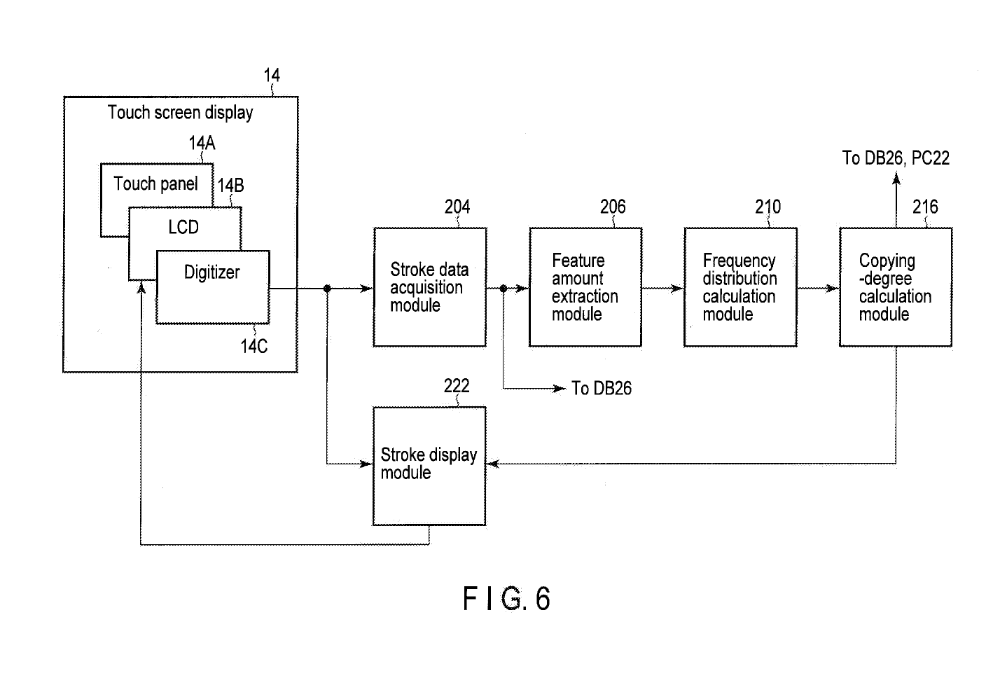

FIG. 6 shows a functional configuration example of the copying-degree calculation program 202 executed in the tablet 10.

The copying-degree calculation program 202 includes, for example, a stroke data acquisition module 204, a feature amount extraction module 206, a frequency distribution calculation module 210, a copying-degree calculation module 216, and a stroke display module 222.

The digitizer 14C is configured to detect occurrence of events, such as “touch,” “move (or slide),” “release,” etc. “Touch” is an event indicating that the stylus has touched the screen. “Move (or slide)” is an event indicating that the touch position has moved while the stylus is touching the screen. “Release” is an event indicating that the stylus is separated from the screen.

The stroke display module 222 and the stroke data acquisition module 204 receive the events of the touch, move (slide) and the release generated by the digitizer 14C, thereby detecting a handwriting input operation. The touch event includes the coordinates of a position where the stylus 16 has been brought into contact with the touch screen display 14. The move (slide) event includes the coordinates of the contact position and the coordinates of a destination to which the stylus has moved. The release event includes the coordinates of a position where the stylus 16 has separated from the touch screen display 14. Therefore, the stroke display module 222 and the stroke data acquisition module 204 can receive, from the digitizer 14C, the coordinates and observation times of sample points (and the stylus pressures, inclinations, etc., of the stylus depending upon the type of the stylus) on the locus of the move of the stylus tip at regular time or space intervals.

The stroke display module 222 receives, from the digitizer 14C, the coordinates, observation time and stylus pressure of each sample point, and displays, on the screen of the LCD 14B, each stroke handwritten by the handwriting input operation using the stylus 16, based on the received data. The thickness of the stroke varies in accordance with the stylus pressure.

The stroke data acquisition module 204 receives the data of the above-mentioned sample points from the digitizer 14C, and generates, based on the received data, stroke data having a structure as shown in, for example, FIG. 4. The stroke data is supplied to the feature amount extraction module 206 and the database 26. The database 26 stores the stroke data indicating a handwritten document.

The feature amount extraction module 206 extracts, from the stroke data, a feature amount indicating a handwriting state. The feature amount extraction module 206 acquires, as a stroke feature amount, at least (1) a statistical value calculated from stroke data corresponding to one stroke, (2) the difference in stroke data between two strokes, or (3) a variation in the stroke data of the two strokes. In consideration of variations in stroke data, normalized data may be used. The same can be applied to a case where data corresponding to strokes obtained at different sampling intervals is used as a comparison target.

The feature amount calculated by the feature amount extraction module 206 is supplied to the frequency distribution calculation module 210. The frequency distribution calculation module 210 calculates a frequency distribution of feature amounts obtained from the stroke data of all strokes included in a handwritten document. Since the degree of copying of a document is calculated based on the frequency distribution, the frequency distribution is calculated in each portion of the document whose degree of copying should be calculated. For instance, the frequency distribution is calculated line by line or paragraph by paragraph. When feature amounts are extracted, the frequency distribution may be calculated feature amount by feature amount, or one frequency distribution may be calculated collectively for the feature amounts. Since the feature amount is associated with stroke data corresponding to one or two strokes, and hence the frequency distribution includes feature amounts associated with a large number of strokes, the frequency distribution is also called an integrated feature amount.

The frequency distribution obtained by the frequency distribution calculation module 210 is supplied to the copying-degree calculation module 216. The copying-degree calculation module 216 obtains the degree of copying by a user from the frequency distribution, using regression expressions, thereby determining whether a writing state is a copying state.

Data indicating the degree of copying or the determination result is supplied from the copying-degree calculation module 216 to the database 26, the computer 22 for teachers, and the stroke display module 222. The database 26 stores data indicating the degree of copying or the determination result in association with stroke data corresponding to a handwritten document. When the computer 22 displays, for example, an answer handwritten by a student, it displays the degree of copying or the determination result, as well. When the LCD 14B of the tablet 10 itself displays the answer, it may also display the degree of copying or the determination result. The degree of copying or the determination result may be displayed independently of the answer. Alternatively, the display style of the answer may be modified so that strokes made while performing copying can be discriminated from those irrelevant to copying.

An example of a feature amount extracted by the feature amount extraction module 206 will be described.

Firstly, (1) an example of a statistical value of stroke data (coordinates, time, stylus pressure, stylus angle) corresponding to one stroke will be described. It is not necessary to calculate all statistical values associated with the coordinates, time, stylus pressure, and stylus angle. It is sufficient if statistical values associated with at least the coordinates and time are calculated. The statistical values associated with the stylus pressure and the stylus angle are dispensable. However, the accuracy of determination may be enhanced if the degree of copying is calculated based on the stylus pressure and the stylus angle, compared to the case where the degree of copying is calculated based on a statistical based on the coordinates and time.

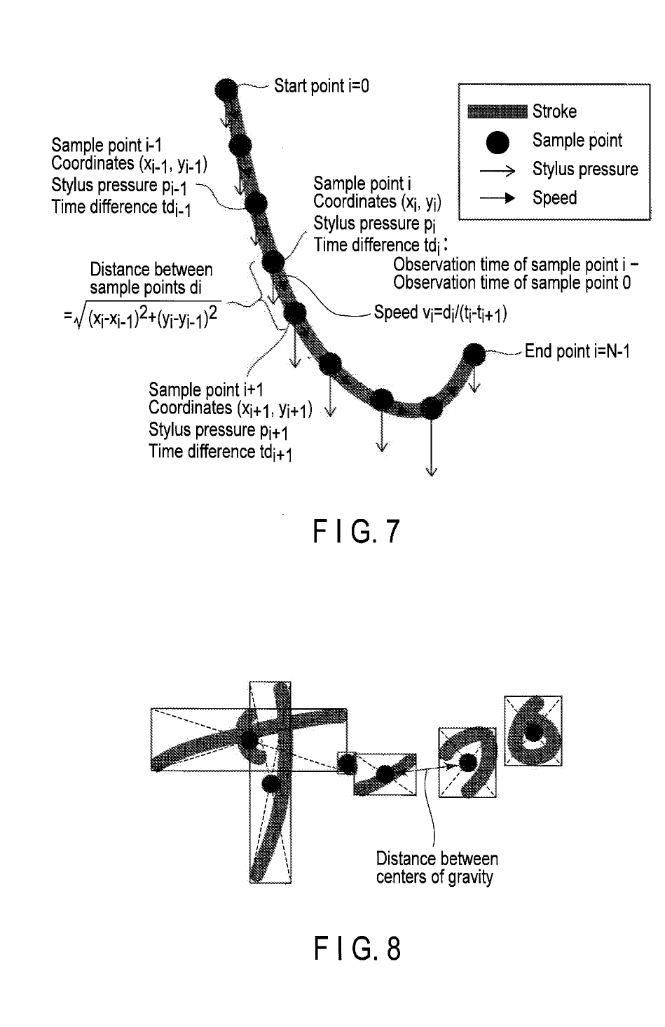

FIG. 7 shows one stroke consisting of N sample points. A variable i attached to each sample point represents 0 to N−1. Assume that the coordinates of sample point i is (xᵢ, yᵢ), the stylus pressure is pᵢ, and the time difference between observation time point t₁ of sample point i and observation time point t₀ of sample point 0 is tdᵢ. In this case, the distance dᵢ between sample points i and i+1 and a writing velocity vᵢ therebetween are defined by the following:

di=\sqrt{(xᵢ₊₁−xᵢ)²+(yᵢ₊₁−yᵢ)²} EQ. 1

vi=di/(tdᵢ₊₁−tdᵢ)

If the distance dᵢ and the writing velocity vᵢ are used, statistical values associated with the length, velocity and acceleration of one stroke will be calculated, as follows:

(1a) Length of one stroke L: Total of distances between respective pairs of adjacent sample points

$$L = {\sum }_{i = 0}^{N - 2} di \qquad EQ . 2$$

(1b) Whole velocity V: Writing velocity of the whole stroke, i.e., stroke length/the time difference between the starting and terminal points of the stroke

V=L/tdₙ₋₁

(1c) Average velocity V(ave): Average of writing velocity between the respective pairs of adjacent sample points, i.e., the average of (the distances between the respective pairs of adjacent sample points/the time differences between the respective pairs of adjacent sample points).

$$V ( ave ) = {\sum }_{i = 0}^{N - 2} Vi / ( N - 2 ) \qquad EQ . 3$$

(1d) Maximum velocity V(max)=Maximum value of the writing velocity between the respective pairs of adjacent sample points

V(max)−max(vi)

i∈{0, 1, . . . , N−2}

(1e) Minimum velocity V(min): Minimum value (except for 0) of the writing velocity between the respective pairs of adjacent sample points

V(min)=min(vi)

i∈{0, 1, . . . , N−2}

(1f) Acceleration A: Acceleration of a stroke

A=V/tdₙ₋₁=L/tdₙ₋₁²

(1g) Average acceleration A(ave): Average of accelerations between the respective pairs of adjacent sample points

$$A ( Ave ) = {\sum }_{i = 1}^{N - 2} ( ( {v}_{i + 1} - {v}_{i} ) / {td}_{i} ) / ( N - 1 ) \qquad EQ . 4$$

(1h) Maximum acceleration A(max): Maximum value of the accelerations between the respective pairs of adjacent sample points

A(max)=max((vᵢ₊₁−vᵢ)/tdᵢ)

i∈{0, 1, . . . , N−2}

(1i) Minimum acceleration A(min): Minimum value (except for 0) of the accelerations between respective pairs of adjacent sample points

A(min)=min((vᵢ₊₁−vᵢ)/tdᵢ)

i∈{0, 1, . . . , N−2}

In the case where stroke data also includes stylus pressure data, statistical values associated with the stylus pressure are also calculated, as follows:

(1j) Average stylus pressure P(ave): Average of stylus pressures at the sample points

$$P ( ave ) = {\sum }_{i = 0}^{N - 1} pi / ( N - 1 ) \qquad EQ . 5$$

(1k) Maximum stylus pressure P(max): Maximum value of the stylus pressures at the sample points

P(max)=max(pᵢ)

i∈{0, 1, . . . , N−1}

(1l) Minimum stylus pressure P(min): Minimum value of the stylus pressures at the sample points

P(min)=min(pᵢ)

i∈{0, 1, . . . , N−1}

If the stroke data further includes the inclination of the stylus, the average, maximum and minimum inclinations of the stylus are calculated, as well as the stylus pressure.

A description will now be given of (2) the difference between stroke data corresponding to two strokes, and (3) variations in the stroke data corresponding to the two strokes.

FIG. 8 shows the distance between the centers of gravity of two strokes as an example of a stroke data difference of the two strokes. Assume here that the centroid of one stroke is the centroid of the circumscribed rectangle of the one stroke.

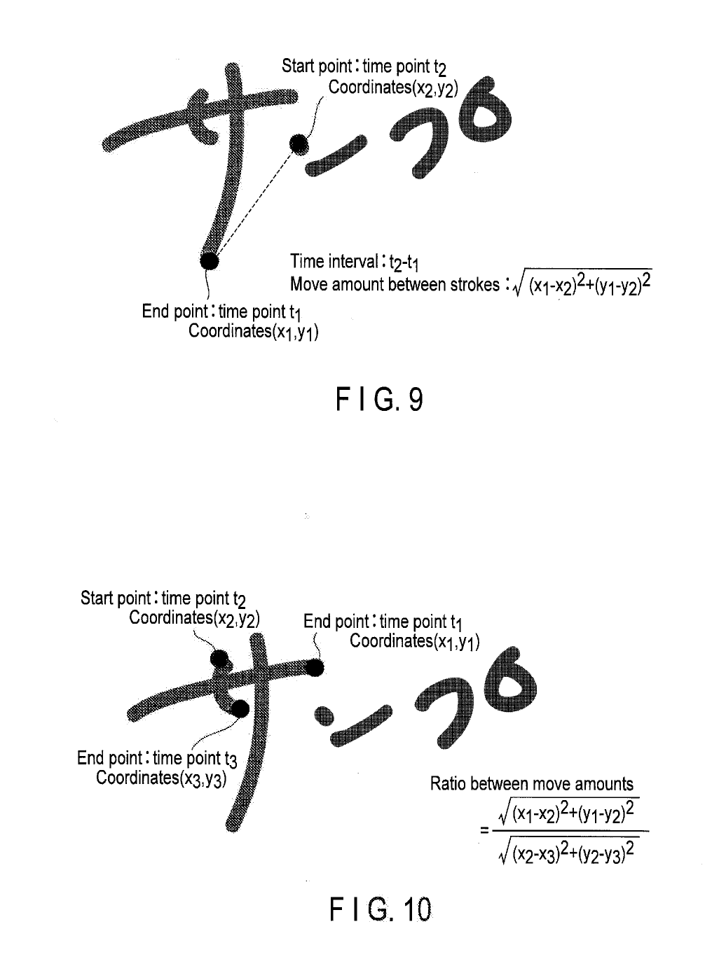

FIG. 9 shows the time difference and move amount between two strokes, as other difference examples of the stroke data corresponding to the two strokes. Assume here that the observation time of the end sample point of the first stroke is t₁, the coordinates of the end sample point are (x₁, y₁), the observation time of the start sample point of the subsequently written second stroke is t₂, and the coordinates of the start sample point are (x₂, y₂). The time difference between the two strokes is obtained by t₂−t₁. The move amount between the two strokes, more specifically, the move amount of from the end point of the first stroke to the start point of the second stroke is given by the following:

\sqrt{(x₁−x₂)²+(y₁−y₂)²} EQ. 6

FIG. 10 shows the ratio of the move amount between two strokes to the move amount of the latter of the two strokes, as an example of a variation in stroke data corresponding to the two strokes. Assume here that the observation time of the end point 1 of the first stroke is t₁, the coordinates of the end point of the first stroke are (x₁, y₁), the observation time of the start point of the second stroke is t₂, the coordinates of the start point of the second stroke are (x₂, y₂), the observation time of the end point 2 of the second stroke is t₃, and the coordinates of the end point 2 of the second stroke are (x₃, y₃). The ratio of the move amount between the two strokes to the move amount of the second stroke is given as follows:

$$\frac{\sqrt{{( {x}_{1} - {x}_{2} )}^{2} + {( {y}_{1} - {y}_{2} )}^{2}}}{\sqrt{{( {x}_{2} - {x}_{3} )}^{2} + {( {y}_{2} - {y}_{3} )}^{2}}} \qquad EQ . 7$$

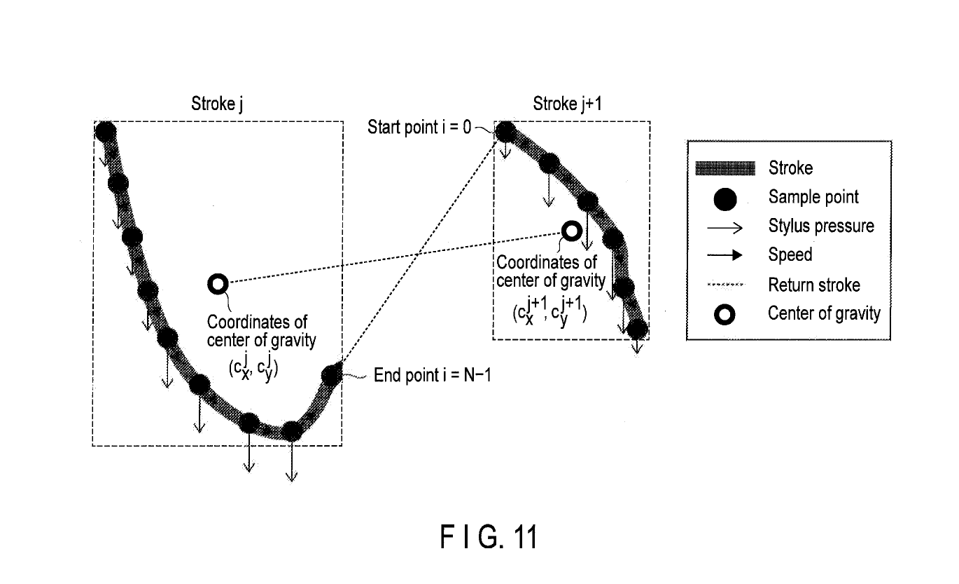

FIG. 11 includes the feature amounts shown in FIGS. 9 and 10, and are used to collectively describe a feature amount obtained from stroke data corresponding to the two strokes.

Assume here that the coordinates of the centers of gravity of two sequential strokes j and j+1 are (c^{j}ₓ, c^{j}_{y}) and (c^{j+1}ₓ, c^{j+1}_{y}), respectively.

(2a) The distance D(c) between the centers of gravity of the two strokes is given by

D(c)=\sqrt{(cₓ^{j}−cₓ^{j+1})²+(c_{y}^{j}−c_{y}^{j+1})²} EQ. 8

(2b) The time difference S between the two strokes, that is, the time difference between the end and start points of two strokes sequential in a time-series manner, is obtained as follows:

S=tⱼ₊₁−tⱼ

(2c) The move amount D between strokes, that is, the distance between the end and start points of two strokes sequential in a time-series manner, is obtained as follows:

D=\sqrt{(x₁−x₂)²+(y₁−y₂)²} EQ. 9

(2d) The ratio RV of the velocity of the stylus during a period until the start of a subsequent stroke, to the writing velocity of the subsequent stroke, that is, the ratio of the move velocity during a period from the start of drawing of a preceding stroke to the start of drawing of the subsequent stroke, to the drawing velocity of the subsequent stroke, is given as follows:

RV=((Lᵢ+D)/(tⱼ₊₁−tⱼ))/VI

where VI indicates the velocity of an I^{th} stroke.

(2e) The ratio of a move amount between two strokes to the move amount of a latter one of the two strokes is given by the above mathematical equation (7).

The difference between stroke data items corresponding to two strokes, and the variation examples in the stroke data items corresponding to the two strokes, are not limited to those recited in the above items (2a) to (2e), but the difference and variations described in the aforementioned items (1a) to (11) may be used.

The frequency distribution calculation module 210 obtains the frequency distribution of the feature amounts of stroke data corresponding to one line of a handwritten document. In the case of horizontal writing, the end point of the last stroke on the line is positioned at the right end of the line, and the start point of the first stroke of a subsequent line is positioned at the left end. Accordingly, when the distance or the time difference between the end and start points is not less than a predetermined value, it can be determined that the two strokes are handwritten on different lines, and stroke data corresponding to each line is extracted from the entire document. Since the frequency distribution is obtained line by line, the degree of copying is also calculated line by line. However, whether copying was performed may be collectively determined several-lines by several-lines, paragraph by paragraph, or page by page. Paragraphs can be detected by detecting a first-line indent or discontinuity between lines.

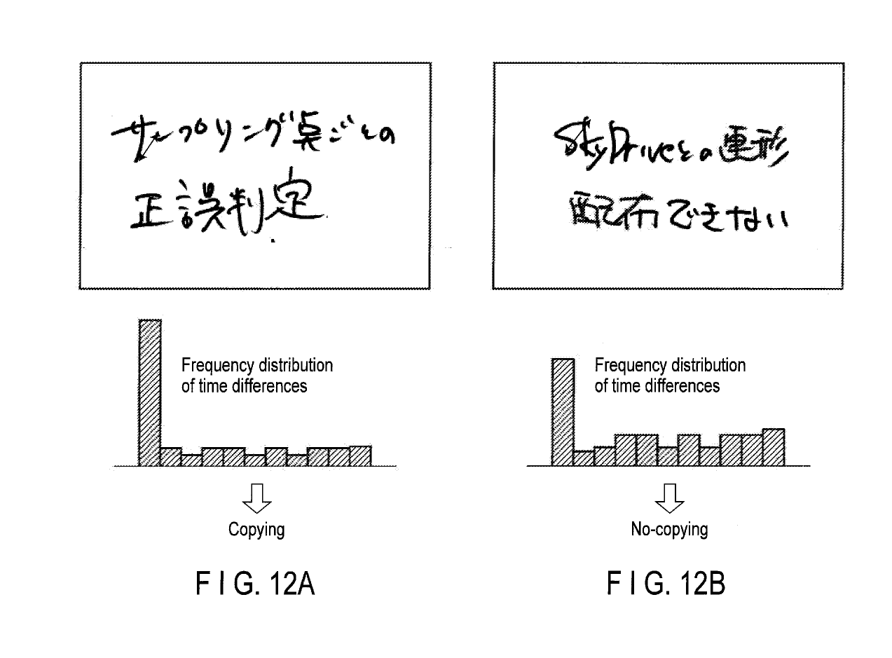

In general, the frequency distribution of feature amounts of stroke data indicating a writing state has a tendency to exhibit a great variance when a story is being written while thinking, and to exhibit a small variance when a document is merely being copied. For instance, in the case of a frequency distribution associated with the time difference or distance between two strokes (more specifically, between the end point of a preceding stroke and the start point of a subsequent stroke), it can be estimated that copying was made, if the absolute frequency in the bin (the range of values—that is, divide the entire range of values into a series of intervals—) including minimum value is not less than a particular threshold (for example, 90%) with respect to a total absolute frequency, as is shown in FIG. 12A. In contrast, it can be estimated that no copying was made, if the absolute frequency in the bin including minimum value is less than the particular threshold with respect to the total absolute frequency, as is shown in FIG. 12B. Alternatively, it can be estimated that no copying was made if there is a bin where the absolute frequency is 0, while it can be estimated that copying was made if there is no such bin.

Actually, the above estimation is performed by the copying-degree calculation module 216, using a regression equation based on a regression analysis. The copying-degree calculation module 216 calculates the degree of copying, using the following regression equation (10) obtained beforehand by learning based on learning data:

f(x̅ᵢ)=w̅^{T}x̅ᵢ+b EQ. 10

where

x̅ᵢ=(x₁, . . . xₘ) EQ. 11

Equation (11) is a frequency distribution calculated by the frequency distribution calculation module 210.

w̅ is a coefficient by which frequency distribution x̅ᵢ is multiplied.

b in equation (10) is a constant, and b and w̅ are determined by learning. m is the absolute frequency of the frequency distribution, and xⱼ is a absolute frequency in bin j.

Since the frequency distribution is obtained line by line, N stroke data items each corresponding to one line are prepared as stroke data for learning. An evaluation value yᵢ for the degree of copying is determined for each learning data item. The greater the amount of copying, the greater the evaluation value. Users may individually perform learning beforehand, or may utilize others' learning results.

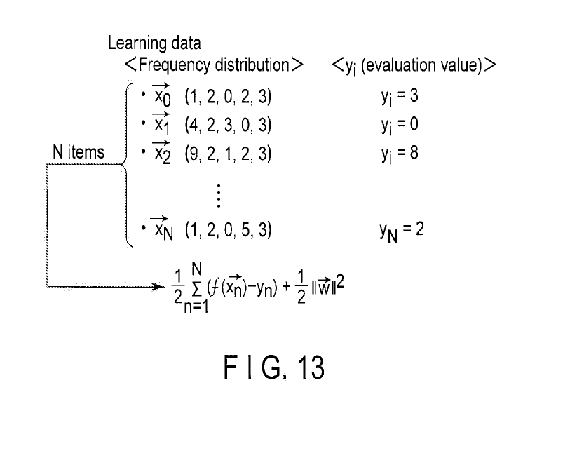

FIG. 13 shows an example of learning. Respective evaluation values yᵢ are predetermined for N frequency distributions of feature amounts of learning data. Coefficient w̅ and b, which minimize errors between the value that is calculated from frequency distributions of feature amounts and the evaluation values,

$$\frac{1}{2} {\sum }_{n = 1}^{N} ( f ( \vec{{x}_{n}} ) - {y}_{n} ) + \frac{1}{2} {‖ \vec{w} ‖}^{2}$$

are calculated.

The learning technique for obtaining the regression equation is not limited to the above-described method, but a known technique may also be utilized.

Thereby, the copying-degree calculation module 216 can obtain the degree of copying line by line from the frequency distribution of feature amounts of the stroke data of a handwriting document. If a determination as to copying or not is performed area by area (greater than lines), the degree of copying in each area is calculated collectively, based on the degree of copying line by line in the area.

The stylus 16 may have an eraser function, as well as a writing function. In this case, if the erase function is turned on, the stylus will serve as an eraser, and can erase stroke data in a portion it traces. The history of this erasure has a correlation with the degree of copying. Since the erase function is little used while copying is being performed, if an erase operation is executed for a long time, or if it is executed again and again, it can be determined that no copying is executed. In order to calculate the degree of copying in consideration of the history of the erase operation, a correction term c corresponding to the period of the erase operation or the number of the erase operations is added to the regression equation. Further, a frequency distribution of erase intervals/frequency may be obtained by learning from stroke data, like the frequency distribution of feature amounts.

f(x̅ᵢ)=w̅^{T}x̅ᵢ+b+c EQ. 15

As described above, in the first embodiment, feature amounts indicating a writing state are extracted from stroke data indicating a user's handwriting history, and it can be determined from a frequency distribution of the feature amounts whether handwriting is copying, using the regression equation. If this embodiment is applied to a learning system wherein a student answers a question given by a teacher, the teacher can know whether the student has copied a correct answer or another student's answer, or whether the student had a lot of trouble in answering the question. Thus, the teacher can acquire useful information to student instruction.

Some operation examples of the embodiment will be described.

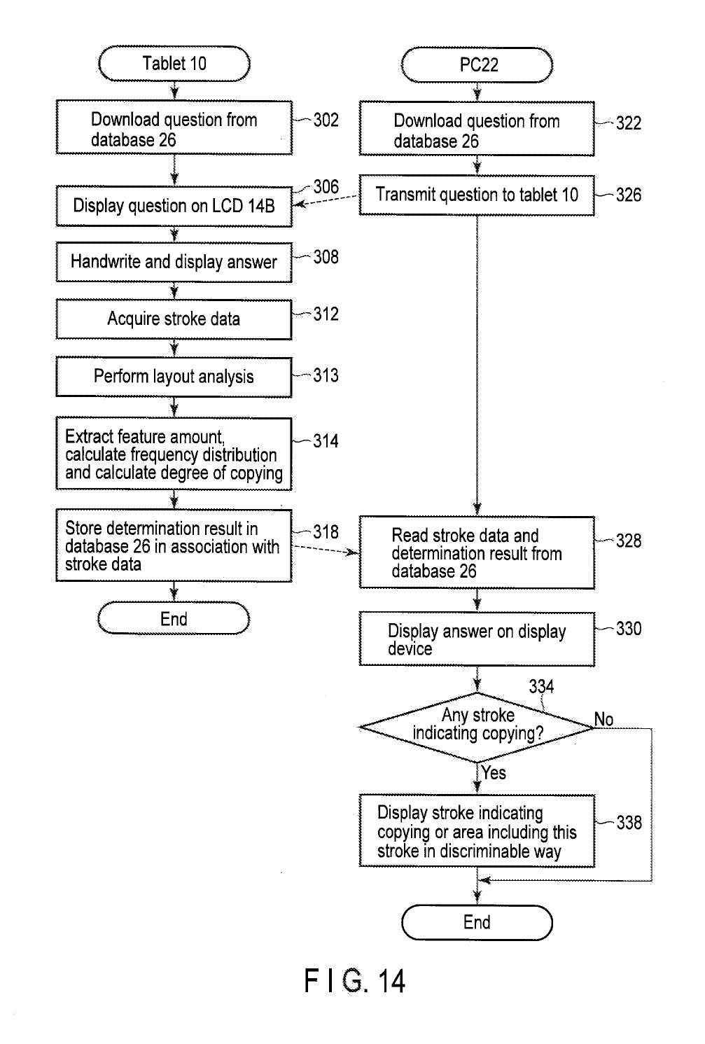

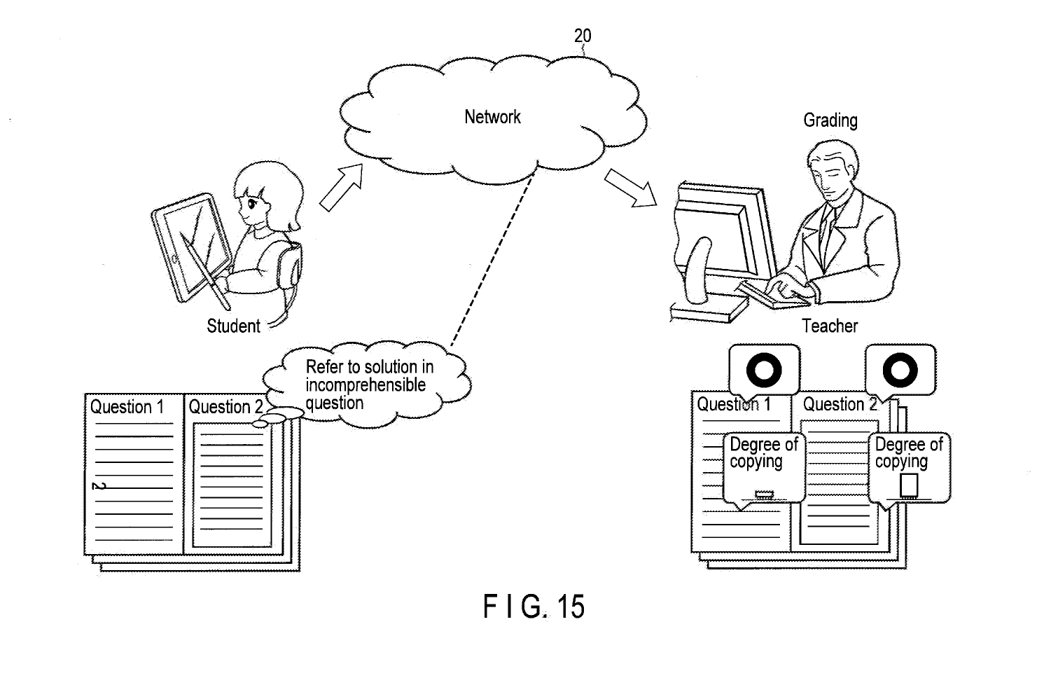

Referring to FIGS. 14 and 15, a first operation example will be described. In the first example, it is assumed that a student is doing a homework assignment at their home, using the tablet 10, or that a teacher and a student are in separate places, and the student attends distance learning, using the tablet 10. FIG. 14 shows a flow of processing performed by the tablet 10 and the computer 22. FIG. 15 shows states of the student and the teacher during the processing of FIG. 14.

In block 302, the tablet 10 used by the student accesses the server 24, thereby downloading a predetermined question from the database 26. In block 306, the question is displayed on the LCD 14B. The question includes a question area and an answer area, and the question area displays, for example, “Describe xx.” In block 308, the student handwrites an answer in the answer area displayed on the LCD 14B, using the stylus 16. Strokes handwritten at this time are displayed on the LCD 14B. When the strokes are handwritten using the stylus 16, the digitizer 14C inputs the coordinates (x, y) of a sample point, observation time data t, stylus pressure p, the inclination of the stylus, etc., and the stroke data acquisition module 204 acquires stroke data as shown in FIG. 4 (block 312).

If the stroke data of the whole answer area is input, a layout analysis is conducted in block 313, and the stroke data of the whole answer area is divided into stroke data items for respective lines. In the layout analysis, it is analyzed whether a document includes paragraphs, lines, diagrams, etc. For instance, when lines and paragraphs are to be analyzed, this analysis is carried out, based on, for example, the distance and the time difference between the end point of a last stroke of a line, and the start point of a first stroke of a subsequent line. In block 314, the frequency distribution of feature amounts of stroke data in each line is calculated, and the degree of copying of the strokes in each line is calculated from the frequency distribution. If, for example, strokes are estimated to indicate copying, they have a high degree of copying. In block 318, the degree of copying is stored in database 26 in association with stroke data.

On the other hand, the computer 22 used by the teacher accesses the server 24 in block 322, thereby downloading a predetermined question from the database 26, and transmits the question to the tablet 10 in block 326. It is sufficient if the question is acquired by the student or teacher. Namely, it is not necessary to execute both blocks 302 and 322.

After the student's learning finishes, the computer 22 reads, from the database 26 in block 328, stroke data corresponding to an answer and the degree of copying or determination result associated with the stroke data. In block 330, the answer is displayed on the display unit. In block 334, it is determined whether the displayed answer is determined to be a copy. If the answer is determined to be a copy, the display mode of strokes corresponding to the answer, or an area including these strokes and determined to be a copy area, is changed in block 338 so that the strokes or area can be discriminated from other strokes or area. For example, the character color or background color of the copying strokes or area is emphasized, or the strokes are made to blink. As a result, when the teacher grades the answer, they can detect the possibility of cheating. In contrast, if portions other than the copied portion are displayed emphasized, the portions of the answer created by the student to solve the question can be specified and used as a clue to detect a student's weak point or cautious point. Further, when a third person other than the student, for example, a parent, sees the answer of the student, the parent can know a laborious portion of the answer to be praised up.

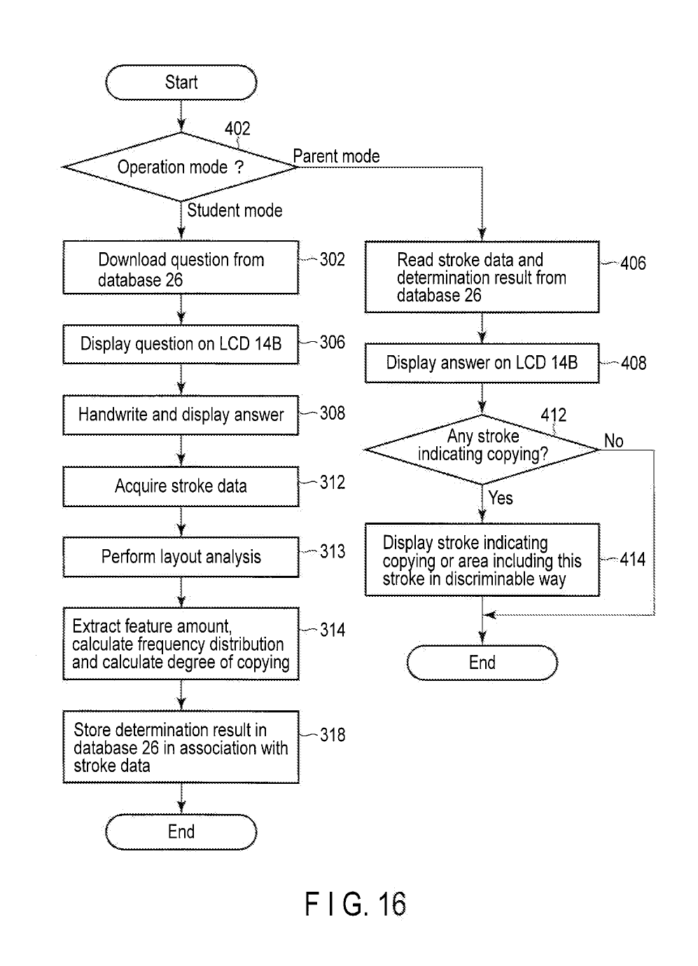

FIG. 16 is a flowchart showing a flow of processing as a second operation example. Assume here that a student (child) and their parent share a single tablet. This tablet has an operation mode switchable between a student mode and a parent mode. When the tablet is in the student mode, the tablet 10 operates as a tablet for the student, and when it is in the parent mode, it operates as the computer 22 for teachers.

In block 402, it is determined whether the operation mode is in the student mode or the parent mode. If it is determined to be the student mode, it operates in the same way as the tablet 10 that operates in accordance with the flowchart of FIG. 14. That is, in block 302, the tablet downloads a predetermined question from the database 26. In block 306, the question is displayed on the LCD 14B. In block 308, the student handwrites an answer in the answer area. The handwritten strokes are displayed on the LCD 14B. When the strokes have been handwritten with the stylus 16, the stroke data acquisition module 204 acquires stroke data as shown in FIG. 4 (block 312).

In block 313, a layout analysis is conducted. In block 314, the frequency distribution of feature amounts of stroke data in each line is obtained to thereby calculate the degree of copying of strokes in each line, from the frequency distribution. In block 318, the degree of copying is stored in the database 26 in association with the stroke data.

In block 402, if the operation mode is determined to be the parent mode, the tablet operates in the same way as the computer 22, as is shown in the flowchart of FIG. 14. That is, in block 406, the tablet reads, from the database 26, stroke data corresponding to the answer, and the degree of copying or determination result associated with the stroke data. In block 408, the answer is displayed on the LCD 14B. In block 412, it is determined whether the displayed answer is determined to be a copy. If the answer is determined to be a copy, the display style of strokes corresponding to the answer, or an area including the strokes and determined to be a copy area, is changed so that the strokes or area can be discriminated from other strokes or area. For instance, the character color or background color of the copying strokes or area is emphasized, or the strokes are made to blink.

When the child (student) is answering, only the strokes corresponding to the answer are displayed, and no determination result is displayed. In contrast, when their parent uses the tablet, both the strokes corresponding to the answer and the determination result as to copying can be displayed. Thus, the single tablet can function as a device for the child and a device for the parent. As well as the parent, a teacher, for example, may use the tablet in the parent mode.

A modification common to the first and second operation examples will be described.

The determination result associated with copying may be noticed to a student who made an answer, in addition to the teacher or parent. For instance, an alert may be output to a student who is performing copying unconsciously. This enables the student to notice, for example, that a currently written sentence is a copy of a reference document (although a time lag inevitably occurs).

The display style of the strokes may not be changed in accordance with the determination result of copying. The determination result of copying may be displayed such that the strokes are rearranged in the order of degrees of copying and attributes (color, brightness, etc.) of strokes corresponding to an answer are changed in accordance with the determination result of copying.

Further, a grader display unit for teachers may be configured such that the answers of a plurality of students are simultaneously displayed, and degrees of copying are attached to the respective answers. This assists the grading task of the teachers. The degrees of copying corresponding to students may be displayed, for example, in different colors for comparison. When simultaneously displaying a large number of answers, the thumbnails of the answers may be displayed and the colors of the thumbnails may be changed in accordance with the degrees of copying of the answers. This enables the teacher to determine an answer to be raised as an example in a school class, or to obtain reference data for grading assignment reports (data for determining an original when reports of the same content are submitted).

Furthermore, when reporting a copying-degree determination result to a student (user) who might cheat, if sentences handwritten by this student are displayed in an order of degrees of non-copying, they can be displayed in an order of sorting (made by the user themselves to sort out the copied content of sentences written by other persons). This assists the user's writing.

Although in the above embodiment, the tablet that was used for handwriting of sentences is also used to perform copying-degree determination of a handwritten document, it may be used only for inputting stroke data, and the feature amount extraction module 206, the frequency distribution calculation module 210, and the copying-degree calculation module 216 may be realized by the computer 22 for teachers, or the server Moreover, feature amount extraction, frequency distribution calculation or copying determination is not necessary to perform simultaneously with or immediately after handwriting. They may be performed when the load of processing is small.

Further, although the embodiment is directed to learning, an alarm can be output also when a storywriter has unconsciously copied document data while writing a story with reference to the data.

The electronic device can be also realized using, for example, a general-purpose computer as basic hardware. Namely, the feature extraction module, feature integration module and measurement module can be realized by causing a processor installed in the computer to execute a program. At this time, the electronic device may be realized by pre-installing the above-mentioned program in the computer, or by installing the program in the computer via a storage medium, such as a CD-ROM, or by downloading the program via a network. Moreover, the storage medium can be realized by appropriately using a memory, a hard disk, or a storage medium, such as a CD-R, a CD-RW, a DVD-RAM, a DVD-R, built in or externally attached to the above-mentioned computer.

The present invention is not limited to the above-described embodiments, but may be modified in various ways without departing from the scope. Various inventions can be realized by appropriately combining the structural elements disclosed in the embodiments. For instance, some of the disclosed structural elements may be deleted. Some structural elements of different embodiments may be combined appropriately.

What is claimed is:

1. A computer-implemented method comprising:
inputting stroke data indicative of a coordinate and time of a handwritten stroke; and
calculating a degree of copying of the handwritten stroke based on a frequency distribution of feature amounts of the input stroke data.

2. The method of claim 1, wherein
the calculating comprises calculating the degree of copying of the handwritten stroke based on a frequency distribution regarding to at least one of a statistical value of stroke data corresponding to one stroke, a difference between stroke data corresponding to two strokes, and a variation in the stroke data corresponding to two strokes.

3. The method of claim 2, wherein
the statistical value of the stroke data corresponding to one stroke comprises at least one of a stroke length, a writing velocity and an acceleration; and
the difference between the stroke data corresponding to two strokes comprises at least one of a distance between centroids of two strokes, a time difference between two strokes, and a move amount between two strokes.

4. The method of claim 1, wherein the stroke data indicates a handwriting pressure of stroke.

5. The method of claim 4, wherein the calculating comprises calculating the degree of copying of the handwritten stroke, based on a frequency distribution regarding to at least one of a statistical value of stroke data corresponding to one stroke, a difference between stroke data corresponding to two strokes, and a variation in the stroke data corresponding to the two strokes.

6. The method of claim 5, wherein
the statistical value of the stroke data corresponding to one stroke comprises at least one of a stroke length, a writing velocity and an acceleration; and
the difference between stroke data corresponding to two strokes comprises at least one of a distance between centroids of the two strokes, a time difference between the two strokes, and a move amount between the two strokes.

7. The method of claim 1, further comprising displaying handwritten strokes wherein a first stroke or a first area including the first stroke is displayed in a style different from a style of stroke other than the first stroke or of area other than the first area, the degree of copying of the first stroke being higher than a first degree.

8. The method of claim 7, wherein
the calculating comprises calculating the degree of copying of the handwritten strokes in a line or lines based on the frequency distribution of a line; and
the displaying comprises displaying the first stroke or the first area including the first stroke in a style different from a style of stroke data other than the first stroke data or areas other than the first area, the degree of copying or the first stroke determined in a line or lines being higher than the first degree.

9. The method of claim 1, further comprising:
displaying a question for learning read from a storage module and including an answer area;
writing, to the storage module, a degree of copying of a stroke handwritten in the answer area in associated with stroke data; and
displaying the stroke data and the degree of copying read from the storage module.

10. The method of claim 1, wherein the calculating comprises calculating the degree of copying from the frequency distribution using a repression equation.

11. The method of claim 10, further comprising:
correcting the regression equation in accordance with a history of a stroke erase operation.

12. A system comprising:
an input module configured to input stroke data indicative of a coordinate and time of a handwritten stroke; and
a calculation module configured to calculate a degree of copying of the handwritten stroke based on a frequency distribution of feature amounts of the input stroke data.

13. The system of claim 12, wherein the stroke data indicates a handwriting pressure of stroke.

14. The system of claim 12, further comprising:
a display module configured to display handwritten strokes; and
a display controller configured to display a first stroke or a first area including the first stroke in a style different from a style of stroke other than the first stroke or area other than the first area, the degree of copying of the first stroke being higher than a first degree.

15. The system of claim 14, further comprising:
a first unit comprising the input module; and
a second unit comprising the calculation module,
wherein the display module is included in the first or second unit.

16. A non-transitory computer-readable storage medium storing a computer program which is executable by a computer, the computer program causing the computer to execute functions of:
inputting stroke data indicative of a coordinate and time of a handwritten stroke; and
calculating a degree of copying of the handwritten stroke based on a frequency distribution of feature amounts of the input stroke data.
